(19) United States
(12) Patent Application Publication
(10) Pub. No.: US 2026/0175713 A1
(43) Pub. Date: Jun. 25, 2026

(54) POWER TRANSMISSION DEVICE

(71) Applicants: TOYOTA JIDOSHA KABUSHIKI KAISHA, Toyota-shi, Aichi (JP); DENSO CORPORATION, Kariya-shi, Aichi (JP)

(72) Inventors: Kazutaka KIMURA, Mishima-shi, Shizuoka-ken (JP); Toshiya HASHIMOTO, Miyoshi-shi, Aichi-ken (JP); Makoto HASHIMOTO, Seto-shi, Aichi-ken (JP); Kazuyoshi OBAYASHI, Kariya-shi, Aichi-ken (JP); Masaki KANESAKI, Kariya-shi, Aichi-ken (JP); Keisuke TANI, Kariya-shi, Aichi-ken (JP); Nobuhisa YAMAGUCHI, Kariya-shi, Aichi-ken (JP); Yuichi TAKEMURA, Kariya-shi, Aichi-ken (JP)

(73) Assignees: TOYOTA JIDOSHA KABUSHIKI KAISHA, Toyota-shi, Aichi (JP); DENSO CORPORATION, Kariya-shi, Aichi (JP)

(21) Appl. No.: 19/123,162

(22) PCT Filed: Aug. 29, 2023
(86) PCT No.: PCT/JP2023/031229

§ 371 Date: Apr. 22, 2025

(30) Foreign Application Priority Data
Oct. 28, 2022 (JP) 2022-173716

(51) Int. Cl. B60L 53/122; B60L 53/126; H02J 50/70

(52) U.S. Cl. CPC B60L 53/122; B60L 53/126; H02J 50/70

(57) ABSTRACT

A power transmission device used to transmit a power in a wireless manner with another power transmission device, has: an annular coil 22, 24 that transmits or receives the power in a wireless manner; and an annular shield member 51 disposed on a side opposite to a side of the another power transmission device with respect to the coil in a power transmission direction D. The shield member at least partially overlaps the coil when viewed in the power transmission direction, and an inner periphery of the shield member is located outside a position inside by a length four times a gap between the coil and the shield member from an inner periphery of the coil when viewed in the power transmission direction.

### CROSS REFERENCE TO RELATED APPLICATIONS

This application is a National Stage of International Application No. PCT/JP2023/031229 filed Aug. 29, 2023, claiming priority based on Japanese Patent Application No. 2022-173716 filed Oct. 28, 2022.

### TECHNICAL FIELD

The present disclosure relates to a power transmission device.

### BACKGROUND ART

In the known art, a ground power supply device that transmits electrical power to a traveling vehicle has been known (for example, JP 2020-150754 A). In particular, the ground power supply device described in JP 2020-150754 A includes a power transmission coil and a shield member that shields an electromagnetic field of the power transmission coil, and the power transmission coil is disposed inside the shield member when viewed from a surface side of a road. In addition, JP 2020-150754 A discloses that an auxiliary shield member is provided inside the shield member.

### SUMMARY OF INVENTION

In the power transmission device such as the ground power supply device described in JP 2020-150754 A, there is room for improvement in the structure and arrangement of the shield member in order to effectively reduce loss due to the leaked magnetic field.

In view of the above problem, an object of the present disclosure is to provide a power transmission device including a shield member capable of effectively reducing loss due to a leaked magnetic field.

The gist of the present disclosure is as follows:
(1) A power transmission device used to transmit a power in a wireless manner with another power transmission device, the power transmission device comprising:
a coil that transmits or receives the power in a wireless manner, the coil having an annular shape; and
a shield member disposed on a side opposite to a side of the another power transmission device with respect to the coil in a power transmission direction, the shield member having an annular shape,
wherein the shield member at least partially overlaps the coil when viewed in the power transmission direction, and an inner periphery of the shield member is located outside a position inside by a length four times a gap between the coil and the shield member from an inner periphery of the coil when viewed in the power transmission direction.
(2) The power transmission device according to above (1), wherein when viewed in the power transmission direction, the shield member is configured in such a way that an outer periphery of the shield member is located inside a position outside an outer periphery of the coil by a length four times the gap.
(3) The power transmission device according to above (1) or (2), wherein when viewed in the power transmission direction, the shield member is configured in such a way that the outer periphery of the shield member is located outside a position outside the outer periphery of the coil by a length twice the gap, and/or the inner periphery of the shield member is located inside a position inside the inner periphery of the coil by the length twice the gap.
(4) A power transmission device used to transmit a power in a wireless manner with another power transmission device, the power transmission device comprising:
a coil that transmits or receives the power in a wireless manner, the coil having an annular shape;
a shield member disposed on a side opposite to a side of the another power transmission device with respect to the coil in a power transmission direction; and
an annular magnetic member provided between the coil and the shield member,
wherein the shield member at least partially overlaps the coil when viewed in the power transmission direction, and an inner periphery of the shield member is located outside a position inside by a length four times a gap between the coil and the shield member from an inner periphery located inside among an inner periphery of the coil and an inner periphery of the magnetic member when viewed in the power transmission direction.
(5) The power transmission device according to above (4), wherein when viewed in the power transmission direction, the shield member is configured in such a way that an outer periphery of the shield member is located inside a position outside by the length four times the gap from an outer periphery located outside among an outer periphery of the coil and an outer periphery of the magnetic member.
(6) The power transmission device according to above (4) or (5), wherein when viewed in the power transmission direction, the shield member is configured in such a way that the outer periphery of the shield member is located outside a position outside by a length twice the gap from the outer periphery located outside among the outer periphery of the coil and the outer periphery of the magnetic member, and/or the inner periphery of the shield member is located inside a position inside by the length twice the gap from the inner periphery located inside among the inner periphery of the coil and the inner periphery of the magnetic member.
(7) The power transmission device according to any one of above (1) to (6), wherein the coil is disposed so as to extend on a plane parallel to a road surface as a whole, and the shield member extends on the plane parallel to the road surface as a whole.
(8) The power transmission device according to any one of above (1) to (7), wherein the shield member extends in such a direction that at least a part of the shield member includes a component in the power transmission direction.
(9) The power transmission device according to above (8), wherein the outer periphery of the shield member extends in the power transmission direction.
(10) The power transmission device according to any one of above (1) to (9), wherein the power transmission device is a ground power supply device used to transmit a power to a vehicle in a wireless manner, and the coil is disposed on a road surface side with respect to a metal buried object on a road in which the metal buried object is buried.
(11) The power transmission device according to above (10), wherein the metal buried object is disposed in such a way that a distance from the coil is 400 mm or less, or in such a way that the distance from the coil is twice or less a distance between a power reception coil of the vehicle that receives the power in a wireless manner and the coil.
(12) The power transmission device according to any one of above (1) to (11), comprising an inverter circuit that supplies the power to the coil.

### BRIEF DESCRIPTION OF DRAWINGS

FIG. 1 is a diagram schematically illustrating a configuration of a wireless power supply system including a ground power supply device.

FIG. 2 is a diagram schematically illustrating an underground cross section of a road in which a power transmission coil is embedded.

FIGS. 3A and 3B are diagrams schematically illustrating a configuration of the power transmission coil and a shield member.

FIG. 4 is a diagram illustrating a relationship between a protrusion amount of the shield member on one side from the power transmission coil and a loss generated in a reinforcing bar.

FIGS. 5A and 5B are diagrams schematically illustrating a configuration of the power transmission coil and the shield member.

FIGS. 6A and 6B are diagrams similar to FIGS. 3A and 3B, schematically illustrating a configuration of a power transmission coil, a core, and a shield member according to a second embodiment.

FIG. 7 illustrates a relationship between a protrusion amount on one side from a core of a shield member and a loss generated in a reinforcing bar.

FIGS. 8A and 8B are diagrams similar to FIGS. 3A and 3B, schematically illustrating a configuration of a power transmission coil and a shield member according to a third embodiment.

FIG. 9 illustrates a relationship between an excess length of a second portion of the shield member from a first portion and a loss generated in a reinforcing bar.

### DESCRIPTION OF EMBODIMENTS

Hereinafter, embodiments will be described in detail with reference to the drawings. In the following description, similar components are denoted by the same reference numerals.

### First Embodiment

### <Outline of Wireless Power Supply System>

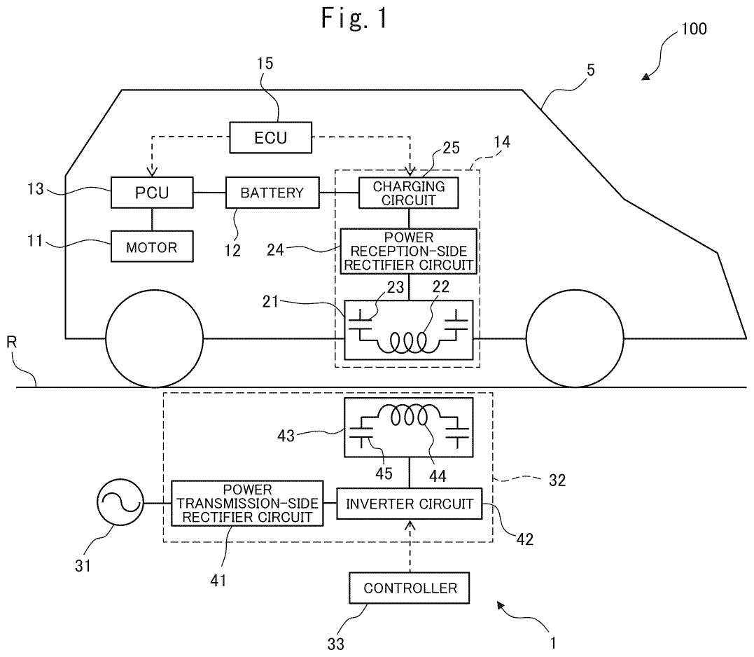

FIG. 1 is a diagram schematically illustrating a configuration of a wireless power supply system 100 including a ground power supply device 1 according to a first embodiment. The wireless power supply system 100 includes a ground power supply device 1 provided in a road R and a vehicle 5 capable of receiving a power from the ground power supply device 1. In the wireless power supply system 100, wireless power is transmitted by magnetic field resonance coupling (magnetic field resonance) from the ground power supply device 1 to the vehicle 5. The ground power supply device 1 functions as a power transmission device used to transmit electrical power in a wireless manner to the vehicle 5. Further, the vehicle 5 functions as a power transmission device used to transmit electrical power in a wireless manner to the ground power supply device 1. In the present embodiment, the wireless power transmission is performed not only when the vehicle 5 is stopped but also while the vehicle 5 is traveling.

The ground power supply device 1 includes a power transmission unit 32 configured to transmit the power to the vehicle 5 in a wireless manner, and the vehicle 5 includes a power reception unit 14 configured to receive the power in a wireless manner. When the electrical power is supplied to the power transmission unit 32 of the ground power supply device 1, a magnetic field is generated by a power transmission coil 44 of the power transmission unit 32. When a power reception coil 22 of the power reception unit 14 of the vehicle 5 is located on the power transmission coil 44, a current flows through the power reception coil 22 by the magnetic field generated by the power transmission coil 44, and thus, the power is received by the power reception unit 14.

### <Configuration of Vehicle>

Next, a configuration of the vehicle 5 will be described with reference to FIG. 1. As illustrated in FIG. 1, the vehicle 5 includes a motor 11, a battery 12, a power control unit (PCU) 13, a power reception unit 14, and an electronic control unit (ECU) 15. The vehicle 5 is an electric vehicle (BEV) in which the motor 11 drives the vehicle 5, or a hybrid vehicle (HEV) in which an internal combustion engine, in addition to the motor 11, drives the vehicle 5.

The motor 11 is, for example, an AC synchronous motor, and functions as an electric motor and a generator. When the motor 11 functions as an electric motor, the motor 11 is driven using the power stored in the battery 12 as a power source. The output of the motor 11 is transmitted to the wheel via a reduction gear and an axle.

The battery 12 is a rechargeable secondary battery, and includes, for example, a lithium ion battery, a nickel hydrogen battery, or the like. The battery 12 stores the power necessary for traveling of the vehicle 5 (for example, driving electric power of the motor 11). When the power received by the power reception unit 14 is supplied to the battery 12, the battery 12 is charged. When the battery 12 is charged, the charged rate (SOC: State of Charge) of the battery 12 is recovered. The battery 12 may also be chargeable by an external power source other than the ground power supply device 1 via a charging port provided in the vehicle 5.

The PCU 13 is electrically connected to the motor 11 and the battery 12. The PCU 13 includes an inverter, a boost converter, and a DC/DC converter. The inverter converts the DC power supplied from the battery 12 into the AC power, and supplies the AC power to the motor 11. The boost converter boosts the voltage of the battery 12 as necessary when the power stored in the battery 12 is supplied to the motor 11. The DC/DC converter steps down the voltage of the battery 12 when the power stored in the battery 12 is supplied to an electronic device such as a headlight.

The power reception unit 14 receives the power from the power transmission unit 32 and supplies the received power to the battery 12. The power reception unit 14 includes a power reception-side resonance circuit 21, a power reception-side rectifier circuit 24, and a charging circuit 25.

The power reception-side resonance circuit 21 is disposed at a bottom of the vehicle 5 so that a distance from the road surface is small. The power reception-side resonance circuit 21 includes the power reception coil 22 and a power reception-side resonance capacitor 23. In the present embodiment, the power reception coil 22 is disposed so as to have a distance from the road surface of a predetermined set distance. The power reception coil 22 is configured such that a current flows through the power reception coil 22 when a magnetic field is generated around the power reception coil. The power reception coil 22 and the power reception-side resonance capacitor 23 constitute a resonator. Various parameters (the outer diameter and inner diameter of the power reception coil 22, the number of turns of the power reception coil 22, the electrostatic capacitance of the power reception-side resonance capacitor 23, and the like) of the power reception coil 22 and the power reception-side resonance capacitor 23 are determined such that the resonance frequency of the power reception-side resonance circuit 21 matches the resonance frequency of the power transmission-side resonance circuit 43. As long as a deviation amount between the resonance frequency of the power reception-side resonance circuit 21 and the resonance frequency of the power transmission-side resonance circuit 43 is small, for example, as long as the resonance frequency of the power reception-side resonance circuit 21 is within a range of ±10% of the resonance frequency of the power transmission-side resonance circuit 43, the resonance frequency of the power reception-side resonance circuit 21 does not necessarily coincide with the resonance frequency of the power transmission-side resonance circuit 43.

The power reception-side rectifier circuit 24 is electrically connected to the power reception-side resonance circuit 21 and the charging circuit 25. The power reception-side rectifier circuit 24 rectifies the AC power supplied from the power reception-side resonance circuit 21 to convert the AC power into the DC power, and supplies the DC power to the charging circuit 25. The power reception-side rectifier circuit 24 is, for example, an AC/DC converter.

The charging circuit 25 is electrically connected to the power reception-side rectifier circuit 24 and the battery 12. The charging circuit 25 converts the DC power supplied from the power reception-side rectifier circuit 24 into a voltage level of the battery 12, and supplies the DC power to the battery 12. When the power transmitted from the power transmission unit 32 is supplied to the battery 12 by the power reception unit 14, the battery 12 is charged. The charging circuit 25 is, for example, a DC/DC converter.

An ECU 15 performs various controls of the vehicle 5. For example, the ECU 15 is electrically connected to the charging circuit 25 of the power reception unit 14, and controls the charging circuit 25 to control charging of the battery 12 by the power transmitted from the power transmission unit 32. Furthermore, the ECU 15 is electrically connected to the PCU 13, and controls the PCU 13 to control exchange of the power between the battery 12 and the motor 11.

### <Configuration of Ground Power Supply Device>

Next, a configuration of the ground power supply device 1 will be schematically described with reference to FIG. 1. As illustrated in FIG. 1, the ground power supply device 1 includes a power source 31, the power transmission unit 32, and a controller 33.

The power source 31 supplies the power to the power transmission unit 32. The power source 31 is, for example, a commercial AC power supply that supplies single-layer AC power. The power source 31 may be another AC power source that supplies three-phase AC power, or may be a DC power source such as a fuel cell.

The power transmission unit 32 transmits the power supplied from the power supply 31 to the vehicle 5 in a wireless manner. The power transmission unit 32 includes a power transmission-side rectifier circuit 41, an inverter circuit 42, and the power transmission-side resonance circuit 43. As illustrated in FIG. 1, the power transmission-side resonance circuit 43 of the power transmission unit 32, particularly, the power transmission coil 44 of the power transmission-side resonance circuit 43, is embedded, in a line, in the road R (underground) on which the vehicle 5 travels, for example, at the center of a lane on which the vehicle 5 travels. The power transmission-side rectifier circuit 41 and the inverter circuit 42 of the power transmission unit 32 may be embedded underground or may be disposed on the ground.

The power transmission-side rectifier circuit 41 is electrically connected to the power source 31 and the inverter circuit 42. The power transmission-side rectifier circuit 41 rectifies an AC power supplied from the power source 31 to convert the AC power into a DC power, and supplies the DC power to the inverter circuit 42. The power transmission-side rectifier circuit 41 is, for example, an AC/DC converter. In the present embodiment, one power transmission unit 32 is provided with one power transmission-side rectifier circuit 41. When the power source 31 is the DC power source, the power transmission-side rectifier circuit 41 may be omitted.

The inverter circuit 42 is electrically connected to the power transmission-side rectifier circuit 41 and the power transmission-side resonance circuit 43. The inverter circuit 42 converts the DC power supplied from the power transmission-side rectifier circuit 41 into an AC power (high-frequency AC power) having a higher frequency than that of the AC power of the power source 31, and supplies the high-frequency AC power to the power transmission-side resonance circuit 43. In the present embodiment, one power transmission unit 32 includes the inverter circuits 42 of which the number corresponds to the number of power transmission-side resonance circuits 43. Each of the inverter circuits 42 is connected to one of the corresponding power transmission-side resonance circuits 43 different from each other.

The power transmission-side resonance circuits 43 includes the power transmission coil 44 and a power transmission-side resonance capacitor 45. The power transmission coil 35 is formed in an annular shape, and generates a magnetic field so as to transmit power in a wireless manner, when an electrical current flows through the power transmission coil 35. The power transmission coil 44 and the power transmission-side resonance capacitor 45 constitute a resonator. Various parameters (the outer shape and inner diameter of the power transmission coil 44, the number of turns of the power transmission coil 44, electrostatic capacitance of the power transmission-side resonance capacitor 45, and the like) of the power transmission coil 44 and the power transmission-side resonance capacitor 45 are determined such that a resonance frequency of the power transmission unit 32 becomes a predetermined set value. The predetermined set value is, for example, from 10 kHz to 100 GHz, and is preferably 85 kHz defined by the SAE TIR J2954 standard as a frequency band for wireless power transmission.

The controller 33 is, for example, a general-purpose computer, and performs various controls of the ground power supply device 1. In particular, the controller 33 is electrically connected to the inverter circuit 42 of the power transmission unit 32, and controls the inverter circuit 42 to control power transmission by the power transmission unit 32. Specifically, for example, the controller 33 specifies the power transmission coil 44 on which the vehicle 5 is located based on an output from an arbitrary sensor (not illustrated), and controls the inverter circuit 42 to supply the power to the specified power transmission coil 44. The controller 33 includes a processor that executes various processes, and a memory that stores a program for the processor to execute various processes, various data used when the processor executes various processes, and the like.

In the wireless power supply system 100 configured as described above, when the power reception coil 22 of the vehicle 5 faces the power transmission coil 44 of the ground power supply device 1 as illustrated in FIG. 1, the AC power is supplied to the power transmission-side resonance circuit 43, and the alternating magnetic field is generated by the power transmission coil 44. When the alternating magnetic field is generated in this way, oscillation of the alternating magnetic field is transmitted to the power reception coil 22. As a result, an induced current flows in the power reception coil 22 by electromagnetic induction, and an induced electromotive force is generated in the power reception-side resonance circuit 21 by the induced current. That is, the power is transmitted from the power transmission unit 32 including the power transmission-side resonance circuit 43 to the power reception unit 14 including the power reception-side resonance circuit 21.

### <Configuration Around Power Transmission Coil>

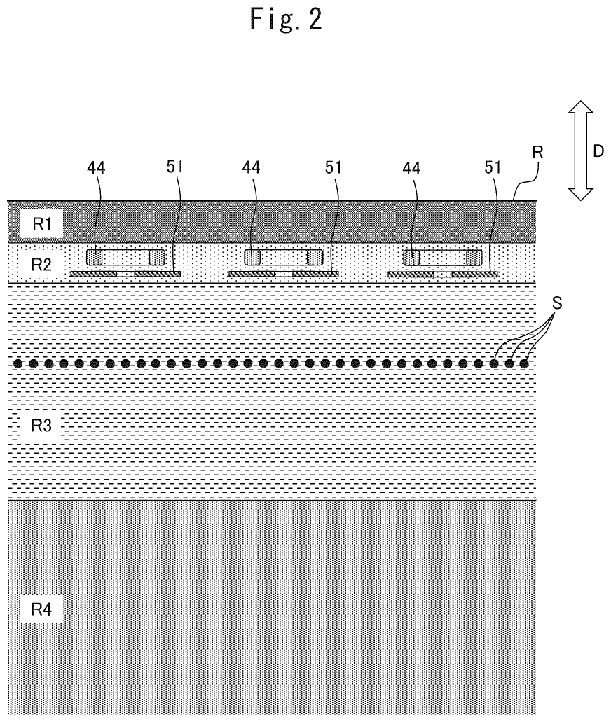

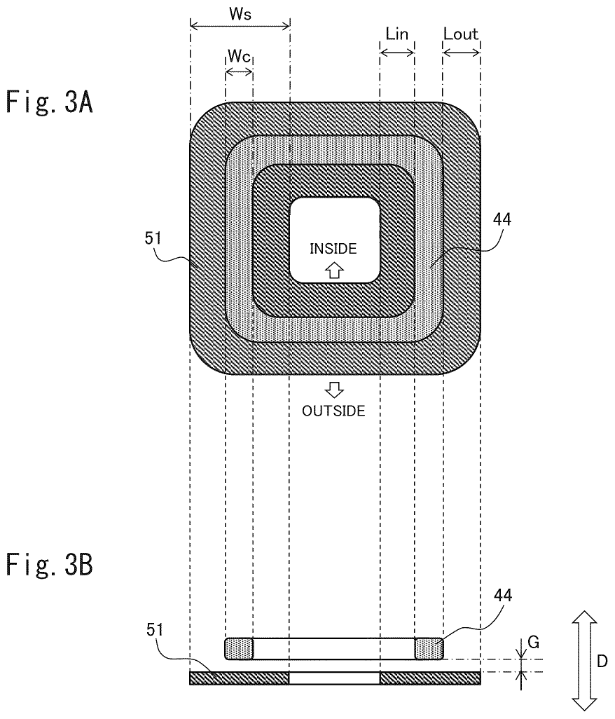

Next, a configuration around the power transmission coil 44 embedded in the road R will be described with reference to FIGS. 2 and 3. FIG. 2 is a diagram schematically illustrating an underground cross section of the road R in which the power transmission coil 44 is embedded.

As illustrated in FIG. 2, the road R is formed including a plurality of layers, with a surface layer R1, an intermediate layer R2, a base layer R3, and a base course R4 being arranged in this order from the surface. The surface layer R1 is a layer exposed to a road surface, and is formed of a material having an appropriate sliding resistance so that the vehicle 5 traveling on the surface layer R1 can safely travel, for example, an asphalt mixture such as high-functional asphalt. The intermediate layer R2 is a layer provided immediately below the surface layer R1, in which the power transmission coil 44 is embedded, and is formed of, for example, an asphalt mixture such as mastic asphalt. The base layer R3 is a layer that is disposed between the intermediate layer R2 and the base course R4 and disperses a traffic load, and is formed of reinforced concrete, for example. Therefore, in the base layer R3, a reinforcing bar S is embedded in a plane parallel to a road surface of the road R. In particular, in the present embodiment, the reinforcing bar S is embedded in a grid pattern in the base layer R3; however, the reinforcing bar may be embedded in any manner as long as the reinforcing bar S is embedded in the plane parallel to the road surface of the road R. The base course R4 is disposed between the base layer R3 and a roadbed (not illustrated), and is formed of, for example, a cement stabilization treatment mixture. In the present embodiment, since the intermediate layer R2 in which the power transmission coil 44 is embedded is located on the road surface side with respect to the base layer R3 in which the reinforcing bar S is embedded, the power transmission coil 44 is provided between the road surface and the reinforcing bar S. In other words, the power transmission coil 44 is disposed on the road surface side with respect to the reinforcing bar S.

Specifically, in the present embodiment, the thickness of the surface layer R1 is, for example, 20 mm to 60 mm, 30 mm to 50 mm, or about 40 mm. The thickness of the intermediate layer R2 is, for example, 20 mm to 60 mm, 30 mm to 50 mm, or about 40 mm. In addition, the thickness of the base layer R3 is, for example, 110 mm to 310 mm, 160 mm to 260 mm, or about 210 mm. In addition, the thickness of the base course R4 is 100 mm to 300 mm, 150 mm to 250 mm, or about 200 mm.

In the present embodiment, the reinforcing bar S is disposed, for example, 30 mm to 110 mm, 50 mm to 90 mm, or about 70 mm below an upper surface of the base layer R3 (boundary surface between the base layer R3 and the intermediate layer R2). In other words, the reinforcing bar S is disposed below the upper surface of the base layer R3 by ½ to ¼ or about ⅓ of the thickness of the base layer R3. In addition, the reinforcing bar S is disposed so as to extend in a direction (longitudinal direction) parallel to a traveling direction of the vehicle 5 and a direction (lateral direction) perpendicular to the traveling direction of the vehicle 5. The reinforcing bars S extending in the direction parallel to the traveling direction of the vehicle 5 are arranged at intervals of 75 mm to 300 mm, at intervals of 100 mm to 200 mm, or at intervals of about 150 mm in the direction perpendicular to the traveling direction of the vehicle 5. On the other hand, the reinforcing bars S extending in the direction perpendicular to the traveling direction of the vehicle 5 are arranged at intervals of 150 mm to 450 mm, at intervals of 200 mm to 400 mm, or at intervals of about 300 mm in the direction parallel to the traveling direction of the vehicle 5.

In the case where the reinforcing bar is provided below the power transmission coil 44, when an alternating magnetic field is generated by the power transmission coil 44, an eddy current is generated in the reinforcing bar by a magnetic flux passing through the reinforcing bar, and a magnetic loss due to the reinforcing bar increases. Thus, in the present embodiment, as illustrated in FIG. 2, an annular shield member 51 is provided between the power transmission coil 44 and the reinforcing bar S.

FIGS. 3A and 3B are diagrams schematically illustrating a configuration of the power transmission coil 44 and the shield member 51. FIGS. 3A and 3B illustrate one power transmission coil 44 and one shield member 51 corresponding to the power transmission coil 44. FIG. 3A is a plan view of the power transmission coil 44 and the shield member 51, and FIG. 3B is a cross-sectional side view of the power transmission coil 44 and the shield member 51.

As illustrated in FIGS. 3A and 3B, the power transmission coil 44 is formed in a rectangular annular shape with rounded corners. As illustrated in FIG. 2, the power transmission coil 44 is disposed so as to extend on the plane parallel to the road surface of the road R as a whole. As illustrated in FIG. 1, when a power reception coil 22 of the vehicle 5 is located on the power transmission coil 44, the power is transmitted from the power transmission coil 44 to the power reception coil 22. Therefore, in the present embodiment, a transmission direction D (hereinafter, simply referred to as the “power transmission direction D”) of the power from the power transmission coil 44 to the power reception coil 22 is a direction perpendicular to the road surface of the road R. The power transmission coil 44 is not necessarily formed in a rectangular annular shape with rounded corners, and may be formed in a circular annular shape, for example. The power transmission coil 44 does not necessarily extend on the plane parallel to the road surface of the road R, and may extend, for example, on a plane inclined with respect to the road surface.

The shield member 51 is used to shield a leaked magnetic field from the power transmission coil 44. The shield member 51 is formed of a material having a relative magnetic permeability of less than 1 in a frequency band for wireless power transmission. Specifically, the shield member 51 is formed of a nonmagnetic body having conductivity such as aluminum, nickel, or copper.

As illustrated in FIGS. 3A and 3B, the shield member 51 is formed in a flat plate shape (see FIG. 3B) and is formed in a rectangular annular shape with rounded corners (see FIG. 3A). A width Ws (length in a direction perpendicular to a circumferential direction of an annular portion of the shield member 51 on a plane parallel to the road surface of the road R) of the annular portion of the shield member 51 is larger than a width Wc (length in a direction perpendicular to a circumferential direction of an annular portion of the power transmission coil 44 on the plane parallel to the road surface of the road R) of the annular portion of the power transmission coil 44. As long as the shield member 51 has a shape similar to that of the power transmission coil 44, the shield member may not necessarily be formed in a rectangular annular shape with rounded corners, and for example, the shield member may be formed in a rectangular annular shape with unrounded corners, a polygonal annular shape other than the quadrangular shape, or a circular annular shape.

As illustrated in FIGS. 3A and 3B, the entire shield member 51 is disposed on a plane parallel to the plane on which the power transmission coil 44 is provided. Therefore, the shield member 51 is disposed so as to extend on the plane parallel to the road surface of the road R as a whole. The shield member 51 is not necessarily disposed in a planar shape parallel to the plane on which the power transmission coil 44 is provided, and may extend, for example, on a plane inclined with respect to the plane on which the power transmission coil 44 is provided.

In addition, the shield member 51 is disposed on a side opposite to the road surface side with respect to the power transmission coil 44 in the power transmission direction D. Thus, when the vehicle 5 is located on the power transmission coil 44, the shield member 51 is disposed on a side opposite to the vehicle 5 side with respect to the power transmission coil 44 in the power transmission direction D.

As illustrated in FIGS. 3A and 3B, the shield member 51 is disposed so as to overlap the power transmission coil 44 when viewed in the power transmission direction D. In particular, in the present embodiment, the shield member 51 is disposed so as to overlap the entire power transmission coil 44 when viewed in the power transmission direction D.

In addition, in the present embodiment, the shield member 51 extends so as to protrude inward from an inner periphery of the power transmission coil 44 when viewed in the power transmission direction D. In particular, in the present embodiment, when the size of a gap between the power transmission coil 44 and the shield member 51 in the power transmission direction D is G, the shield member 51 is configured such that an inner periphery of the shield member 51 is located outside a position inside by a length four times the gap G from the inner periphery of the power transmission coil 44 when viewed in the power transmission direction D. In addition, when viewed in the power transmission direction D, the shield member 51 is configured such that the inner periphery of the shield member 51 is located inside a position inside the inner periphery of the power transmission coil 44 by a length twice the gap G. That is, a distance Lin between the inner periphery of the shield member 51 and the inner periphery of the power transmission coil 44 (protrusion amount of the shield member 51 from the inner periphery of the power transmission coil 44) is set to a length that is from twice to four times the gap G (2G≤Lin≤4G).

In the present embodiment, the shield member 51 extends so as to protrude outward from an outer periphery of the power transmission coil 44 when viewed in the power transmission direction D. In particular, in the present embodiment, when viewed in the power transmission direction D, the shield member 51 is configured such that the outer periphery of the shield member 51 is located inside a position outside the outer periphery of the power transmission coil 44 by a length four times the gap G. In addition, when viewed in the power transmission direction D, the shield member 51 is configured such that the outer periphery of the shield member 51 is located outside a position outside the outer periphery of the power transmission coil 44 by a length twice the gap G. That is, a distance Lout between the outer periphery of the shield member 51 and the outer periphery of the power transmission coil 44 (protrusion amount of the shield member 51 from the outer periphery of the power transmission coil 44) is set to the length that is from twice to four times the gap G (2G≤Lout≤4G).

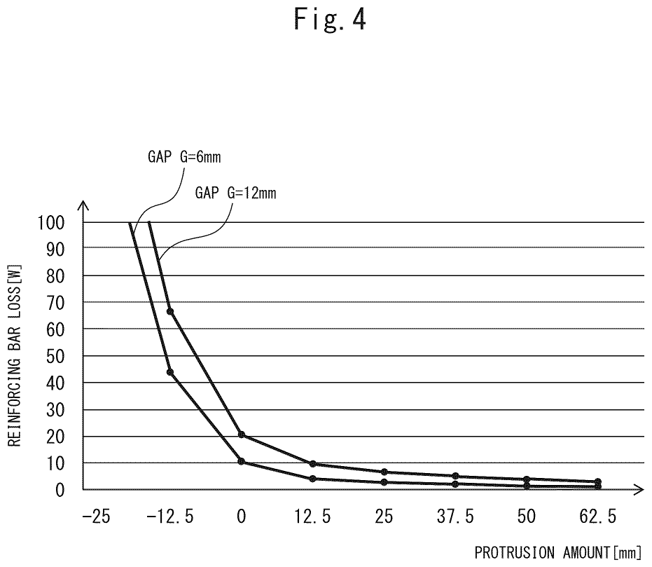

FIG. 4 is a diagram illustrating a relationship between a protrusion amount L of the shield member 51 on one side from the power transmission coil 44 and a loss generated in the reinforcing bar. In particular, FIG. 4 illustrates a case where the thicknesses of the surface layer R1, the intermediate layer R2, the base layer R3, and the base course R4 are 40 mm, 40 mm, 210 mm, and 200 mm, respectively, and the reinforcing bar S is disposed at an interval of 150 mm in the lateral direction and an interval of 300 mm in the longitudinal direction and at 70 mm from the upper surface of the base layer R3. In addition, FIG. 4 illustrates a case where the gap between the shield member 51 and the power transmission coil 44 is 6 mm and a case where the gap is 12 mm.

As illustrated in FIG. 4, when the gap is 6 mm, the loss generated in the reinforcing bar becomes sufficiently small when the protrusion amount is 12.5 mm, and hardly changes when the protrusion amount exceeds 25 mm. Similarly, when the gap is 12 mm, the loss generated in the reinforcing bar becomes sufficiently small when the protrusion amount is 25 mm, and hardly changes when the protrusion amount exceeds 50 mm. Therefore, as in the present embodiment, by configuring the shield member 51 so that the protrusion amount L is the length that is from twice to four times the gap G, it is possible to sufficiently reduce the loss generated in the reinforcing bar while minimizing the material used as the shield member 51.

### Modified Example

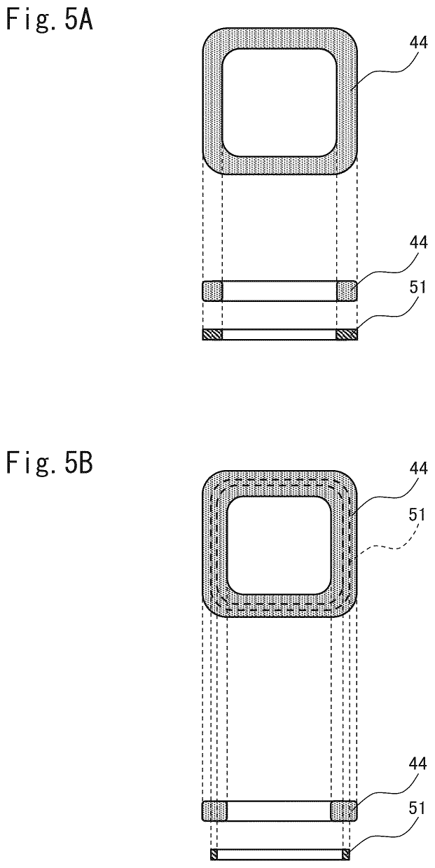

In the above embodiment, the shield member 51 is formed so as to protrude inward from the inner periphery of the power transmission coil 44 and outward from the outer periphery of the power transmission coil 44 when viewed in the power transmission direction D. However, as illustrated in FIG. 5A, the shield member 51 may be formed so as not to protrude from the power transmission coil 44 but to entirely overlap the entire power transmission coil 44 when viewed in the power transmission direction D. As illustrated in FIG. 4, since the loss generated in the reinforcing bar is relatively small even when the protrusion amount L is 0, the loss can be suppressed to be relatively small even when the entire shield member 51 overlaps the entire power transmission coil 44. The shield member 51 may be formed such that only one of the outer periphery and the inner periphery of the shield member 51 is flush with the outer periphery or the inner periphery of the power transmission coil 44 when viewed in the power transmission direction D.

Alternatively, as illustrated in FIG. 5B, when viewed in the power transmission direction D, the shield member 51 may be formed such that an inner periphery of the shield member 51 is retracted outward from the inner periphery of the power transmission coil 44, and the outer periphery of the shield member 51 is retracted inward from the outer periphery of the power transmission coil 44. The shield member 51 may be formed such that only one of the outer periphery and the inner periphery of the shield member 51 is retracted from the outer periphery or the inner periphery of the power transmission coil 44 when viewed in the power transmission direction D. In any case, the shield member 51 is formed so as to at least partially overlap the power transmission coil 44 when viewed in the power transmission direction D. In both the cases of FIGS. 5A and 5B, the shield member 51 is configured such that the outer periphery of the shield member is located inside the position outside the outer periphery of the power transmission coil 44 by the length four times the gap G, and the inner periphery of the shield member is located outside the position inside the inner periphery of the power transmission coil 44 by the length four times the gap G.

In the above embodiment, the case where the reinforcing bar S is embedded in the road as a member that causes the magnetic loss is described as an example. However, the magnetic loss similarly occurs in metal buried objects other than the reinforcing bar S, such as metal gas pipes, water pipes, electric wires for system distribution, and electric wire burying pipes. Therefore, even when the metal buried object other than the reinforcing bar S is buried, the power transmission device according to the present embodiment can be similarly used. In particular, when a distance between the metal buried object and the power transmission coil 44 is short, the shield member 51 is required, and when the distance between the metal buried object and the power transmission coil 44 is 400 mm or less, or twice or less a power transfer distance, the effect obtained by providing the shield member 51 is enhanced. The power transfer distance is a distance between the power reception coil 22 and the power transmission coil 44 provided at a prescribed height of the vehicle 5.

### Second Embodiment

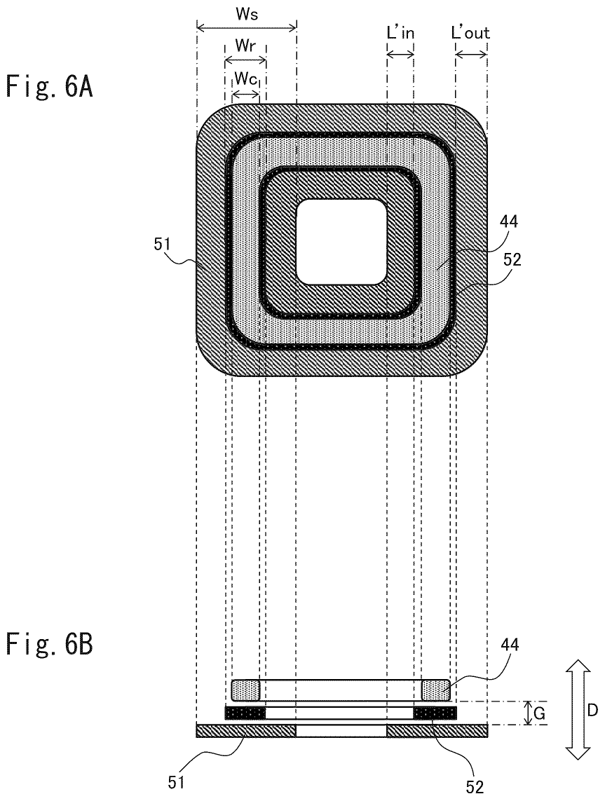

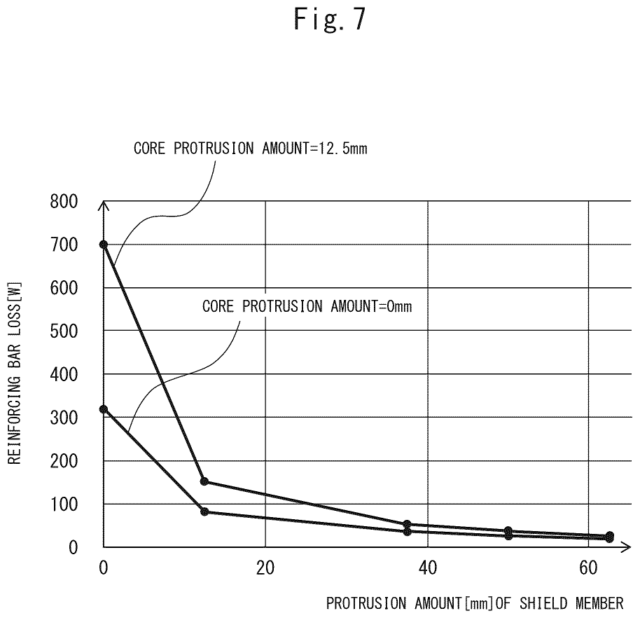

Next, a ground power supply device 1 according to a second embodiment will be described with reference to FIGS. 6A, 6B and 7. The configuration of the ground power supply device 1 according to the second embodiment is basically similar to the ground power supply device 1 according to the first embodiment. Hereinafter, portions different from the ground power supply device 1 according to the first embodiment will be mainly described.

FIGS. 6A and 6B are diagrams similar to FIGS. 3A and 3B, schematically illustrating a configuration of a power transmission coil 44, a core 52, and a shield member 51 according to the second embodiment. FIG. 6A is a plan view of the power transmission coil 44, the core 52, and the shield member 51, and FIG. 6B is a cross-sectional side view of the power transmission coil 44, the core 52, and the shield member 51.

As illustrated in FIGS. 6A and 6B, in the present embodiment, the core 52 is provided between the power transmission coil 44 and the shield member 51 in the power transmission direction D. The core 52 is an example of a magnetic material formed of a magnetic body having high magnetic permeability. The core is formed of, for example, a soft magnetic body such as ferrite, a powder magnetic core, or a dust core. By providing the core 52, a magnetic flux path is created, and as a result the inductance of the power transmission coil 44 can be increased.

As illustrated in FIGS. 6A and 6B, the core 52 is formed in a flat plate shape (see FIG. 6B) and is formed in a rectangular annular shape with rounded corners (see FIG. 6A). A width Wr (length in a direction perpendicular to a circumferential direction of an annular portion of the core 52 on the plane parallel to the road surface of the road R) of the annular portion of the core 52 is larger than the width Wc of the annular portion of the power transmission coil 44 and smaller than the width Ws of the shield member 51. As long as the core 52 has a shape similar to that of the power transmission coil 44, the core may not necessarily be formed in a rectangular annular shape with rounded corners, and for example, the core may be formed in a rectangular annular shape with unrounded corners, a polygonal annular shape other than the quadrangular shape, or a circular annular shape.

As illustrated in FIGS. 6A and 6B, the entire core 52 is disposed on the plane parallel to the plane on which the power transmission coil 44 is provided. Therefore, the core 52 is disposed so as to extend on the plane parallel to the road surface of the road R as a whole. The core 52 is not necessarily disposed in a planar shape parallel to the plane on which the power transmission coil 44 is provided, and may extend, for example, on a plane inclined with respect to the plane on which the power transmission coil 44 is provided.

As illustrated in FIGS. 6A and 6B, the core 52 is disposed so as to overlap the power transmission coil 44 when viewed in the power transmission direction D. In particular, in the present embodiment, the core 52 is disposed so as to overlap the entire power transmission coil 44 when viewed in the power transmission direction D. In addition, in the present embodiment, the core 52 is formed so as to protrude inward from the inner periphery of the power transmission coil 44 when viewed in the power transmission direction D. In addition, in the present embodiment, the core 52 is formed so as to protrude outward from the outer periphery of the power transmission coil 44 when viewed in the power transmission direction D. The core 52 may be formed so as to protrude from only one of the inner periphery and the outer periphery of the power transmission coil 44.

In the present embodiment, the shield member 51 extends so as to protrude inward from an inner periphery of the core 52 when viewed in the power transmission direction D. In particular, in the present embodiment, when the size of a gap between the power transmission coil 44 and the shield member 51 in the power transmission direction D is G, the shield member 51 is configured such that the inner periphery of the shield member 51 is located outside a position inside by a length four times the gap G from the inner periphery of the core 52 when viewed in the power transmission direction D. In addition, when viewed in the power transmission direction D, the shield member 51 is configured such that the inner periphery of the shield member 51 is located inside a position inside the inner periphery of the core 52 by a length twice the gap G. That is, a distance L′in between the inner periphery of the shield member 51 and the inner periphery of the core 52 (protrusion amount of the shield member 51 from the inner periphery of the core 52) is set to a length that is from twice to four times the gap G (2G≤L′in ≤4G).

In the present embodiment, the shield member 51 extends so as to protrude outward from an outer periphery of the core 52 when viewed in the power transmission direction D. In particular, in the present embodiment, when viewed in the power transmission direction D, the shield member 51 is configured such that the outer periphery of the shield member 51 is located inside a position outside the outer periphery of the core 52 by a length four times the gap G. In addition, when viewed in the power transmission direction D, the shield member 51 is configured such that the outer periphery of the shield member 51 is located outside a position outside the outer periphery of the core 52 by a length twice the gap G. That is, a distance L′out between the outer periphery of the shield member 51 and the outer periphery of the core 52 (protrusion amount of the shield member 51 from the outer periphery of the core 52) is set to the length that is from twice to four times the gap G (2G≤L′out≤4G).

FIG. 7 illustrates a relationship between a protrusion amount L′ on one side from the core 52 of the shield member 51 and the loss generated in the reinforcing bar. In particular, FIG. 7 illustrates a relationship when the road R and the reinforcing bar S are set to conditions similar to those in FIG. 4, an interval between the power transmission coil 44 and the core 52 is set to 5 mm, and an interval between the core 52 and the shield member 51 is set to 5 mm. In particular, FIG. 7 illustrates, when viewed in the power transmission direction D, a case where the protrusion amount of the core 52 from the power transmission coil 44 is 0 mm and a case where the protrusion amount is 12.5 mm.

As illustrated in FIG. 7, regardless of whether or not the core 52 protrudes from the power transmission coil 44, if the protrusion amount L′ of the shield member 51 from the core 52 is the same, the loss generated in the reinforcing bar is substantially the same. On the other hand, even when the protrusion amount of the shield member 51 from the power transmission coil 44 is the same, if the protrusion amount L′ of the shield member 51 from the core 52 is different, the loss generated in the reinforcing bar changes. For example, when a case where the protrusion amount of the core 52 from the power transmission coil 44 is 12.5 mm and the protrusion amount L′ of the shield member 51 from the core 52 is 0 mm is compared with a case where the protrusion amount of the core 52 from the power transmission coil 44 is 0 mm and the protrusion amount L′ of the shield member 51 from the core 52 is 12.5 mm, the protrusion amount of the shield member 51 from the power transmission coil 44 is 12.5 mm and the same in both the cases; however, the loss generated in the reinforcing bar is greatly different. In the present embodiment, in the case where the core 52 is provided between the power transmission coil 44 and the shield member 51, the protrusion amount L′ of the shield member 51 from the core 52 is set based on the gap G, so that the loss generated in the reinforcing bar can be suitably reduced.

In the present embodiment, the core 52 protrudes inward from the inner periphery of the power transmission coil 44, and the inner periphery of the core 52 is located inward from the inner periphery of the power transmission coil 44. However, the inner periphery of the core 52 may be located outward from the inner periphery of the power transmission coil 44. In this case, similarly to the first embodiment, the shield member 51 is formed such that the distance between the inner periphery of the shield member and the inner periphery of the power transmission coil 44 is the length that is from twice to four times the gap G. Therefore, when viewed in the power transmission direction D, the shield member 51 is configured such that the inner periphery of the shield member 51 is located inside by from twice to four times the gap G from the inner periphery located inside among the inner periphery of the power transmission coil 44 and the inner periphery of the core 52.

Similarly, in the present embodiment, the core 52 protrudes outward from the outer periphery of the power transmission coil 44, and the outer periphery of the core 52 is located outward from the outer periphery of the power transmission coil 44. However, the outer periphery of the core 52 may be located inward from the outer periphery of the power transmission coil 44. In this case, similarly to the first embodiment, the shield member 51 is formed such that the distance between the outer periphery of the shield member and the outer periphery of the power transmission coil 44 is the length that is from twice to four times the gap G. Therefore, when viewed in the power transmission direction D, the shield member 51 is configured such that the outer periphery of the shield member 51 is located outside by from twice to four times the gap G from the outer periphery located outside among the outer periphery of the power transmission coil 44 and the outer periphery of the core 52.

### Third Embodiment

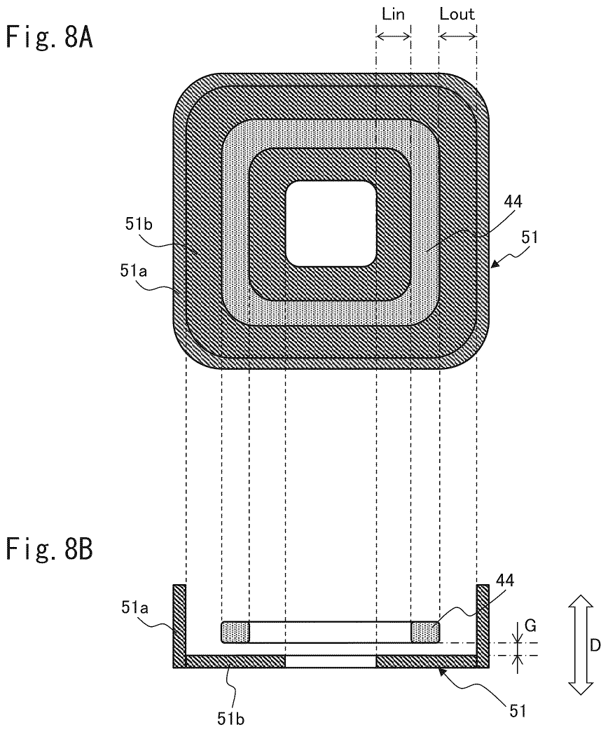

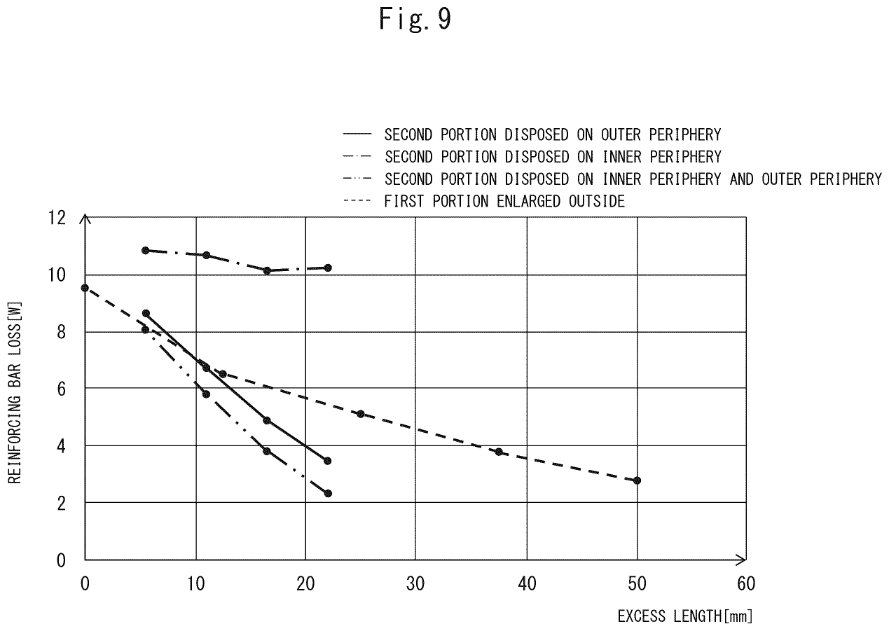

Next, a ground power supply device 1 according to a third embodiment will be described with reference to FIGS. 8A, 8B and 9. The configuration of the ground power supply device 1 according to the third embodiment is basically similar to the ground power supply device 1 according to the first embodiment or the second embodiment. Hereinafter, portions different from the ground power supply device 1 according to the first and second embodiments will be mainly described.

FIGS. 8A and 8B are diagrams similar to FIGS. 3A and 3B, schematically illustrating a configuration of a power transmission coil 44 and a shield member 51 according to the third embodiment. In the first embodiment and the second embodiment, the shield member 51 is formed in a flat plate shape and an annular shape. On the other hand, as illustrated in FIGS. 8A and 8B, in the present embodiment, the shield member 51 is configured to include a first portion 51a, having a flat plate shape and an annular shape, and a cylindrical second portion 51b.

The first portion 51a is configured similarly to the shield member in the first embodiment. The entire first portion 51a is disposed on the plane parallel to the plane on which the power transmission coil 44 is provided. On the other hand, the second portion 51b is configured such that an inner surface of the second portion 51b is coupled to an outer periphery of the first portion 51a. As illustrated in FIGS. 8A and 8B, the second portion 51b extends in a power transmission direction D. In particular, the second portion 51b extends from a coupling portion with the first portion 51a toward the road surface of the road R, that is, toward the vehicle 5 when the vehicle 5 is located on the power transmission coil 44. Therefore, in the present embodiment, the outer periphery of the shield member 51 is formed to extend in the power transmission direction D. The first portion 51a and the second portion 51b of the shield member 51 may be formed separately and coupled, or may be integrally formed.

In the present embodiment, the first portion 51a is configured such that the outer periphery of the shield member 51 is located outward from the outer periphery of the power transmission coil 44 by from one to four times the gap G when viewed in the power transmission direction D. In the present embodiment, the first portion 51a is configured such that the inner periphery of the shield member 51 is located inward from the inner periphery of the power transmission coil 44 by from one to four times the gap G when viewed in the power transmission direction D. In addition, in the present embodiment, the second portion 51b is configured to extend over a length of from one to four times the gap G in the power transmission direction D.

FIG. 9 illustrates a relationship between an excess length of the second portion 51b of the shield member 51 from the first portion 51a and the loss generated in the reinforcing bar. FIG. 9 illustrates a case where the gap G between the first portion 51a of the shield member 51 and the power transmission coil 44 is 6 mm. In addition, FIG. 9 illustrates a case where when viewed in the power transmission direction D, the inner periphery of the first portion 51a is located at 12.5 mm from the inner periphery of the power transmission coil 44 and the outer periphery of the first portion 51a is located at 12.5 mm from the outer periphery of the power transmission coil 44.

A solid line in FIG. 9 indicates a relationship in a case where the second portion 51b extending in the power transmission direction D is disposed on the outer periphery of the first portion 51a as in the present embodiment. The one-dot chain line in FIG. 9 indicates a relationship in a case where the second portion extending in the power transmission direction D is disposed on the inner periphery of the first portion 51a. In addition, the two-dot chain line in FIG. 9 indicates a relationship in a case where the second portion extending in the power transmission direction D is disposed on each of the outer periphery and the inner periphery of the first portion 51a. The excess length in the solid line, the one-dot chain line, and the two-dot chain line represents a length of the second portion in the power transmission direction D from the coupling portion with the first portion. In addition, the broken line in FIG. 9 indicates a case where the shield member is widened outward from the first portion 51a (a case where the second portion extending in the power transmission direction D is not provided). The excess length in the broken line represents a length between an outer periphery of a portion expanding outward from the first portion 51a and the outer periphery of the first portion 51a.

As can be seen from the solid line and the two-dot chain line in FIG. 9, as in the present embodiment, by forming the shield member 51 such that the second portion of the shield member 51 extends in the power transmission direction D from the outer periphery of the first portion 51a, it is possible to reduce the loss generated in the reinforcing bar as compared with a case where the shield member 51 is simply widened outward (broken line in FIG. 9).

In the above embodiment, the second portion 51b is formed to extend in the power transmission direction D. However, as long as the second portion 51b extends so as to have a component in the power transmission direction D, the second portion may not necessarily extend in the power transmission direction D. Therefore, for example, the second portion 51b may be formed so as to obliquely extend outward from the outer periphery of the first portion 51a and toward a road surface direction of the road R.

In the first to third embodiments, the case where the shield member 51 is provided around the power transmission coil 44 of the ground power supply device 1 has been described. However, a shield member may be similarly provided around a power reception coil 22 of the vehicle 5. In this case, the shield member is disposed between the power reception coil 22 and a metal member constituting a vehicle body of the vehicle 5, and a loss in the metal member can be reduced by the shield member.

Although the preferred embodiments according to the present invention have been described above, the present invention is not limited to these embodiments, and various modifications and changes can be made within the scope of the claims.

1. A power transmission device used to transmit a power in a wireless manner with another power transmission device, the power transmission device comprising:
a coil that transmits or receives the power in a wireless manner, the coil having an annular shape; and
a shield member disposed on a side opposite to a side of the another power transmission device with respect to the coil in a power transmission direction, the shield member having an annular shape,
wherein the shield member at least partially overlaps the coil when viewed in the power transmission direction, and an inner periphery of the shield member is located outside a position inside by a length four times a gap between the coil and the shield member from an inner periphery of the coil when viewed in the power transmission direction.

2. The power transmission device according to claim 1, wherein when viewed in the power transmission direction, the shield member is configured in such a way that an outer periphery of the shield member is located inside a position outside an outer periphery of the coil by a length four times the gap.

3. The power transmission device according to claim 1- or 2, wherein when viewed in the power transmission direction, the shield member is configured in such a way that the outer periphery of the shield member is located outside a position outside the outer periphery of the coil by a length twice the gap, and/or the inner periphery of the shield member is located inside a position inside the inner periphery of the coil by the length twice the gap.

4. A power transmission device used to transmit a power in a wireless manner with another power transmission device, the power transmission device comprising:
a coil that transmits or receives the power in a wireless manner, the coil having an annular shape;
a shield member disposed on a side opposite to a side of the another power transmission device with respect to the coil in a power transmission direction; and
an annular magnetic member provided between the coil and the shield member,
wherein the shield member at least partially overlaps the coil when viewed in the power transmission direction, and an inner periphery of the shield member is located outside a position inside by a length four times a gap between the coil and the shield member from an inner periphery located inside among an inner periphery of the coil and an inner periphery of the magnetic member when viewed in the power transmission direction.

5. The power transmission device according to claim 4, wherein when viewed in the power transmission direction, the shield member is configured in such a way that an outer periphery of the shield member is located inside a position outside by the length four times the gap from an outer periphery located outside among an outer periphery of the coil and an outer periphery of the magnetic member.

6. The power transmission device according to claim 4, wherein when viewed in the power transmission direction, the shield member is configured in such a way that the outer periphery of the shield member is located outside a position outside by a length twice the gap from the outer periphery located outside among the outer periphery of the coil and the outer periphery of the magnetic member, and/or the inner periphery of the shield member is located inside a position inside by the length twice the gap from the inner periphery located inside among the inner periphery of the coil and the inner periphery of the magnetic member.

7. The power transmission device according to claim 1, wherein the coil is disposed so as to extend on a plane parallel to a road surface as a whole, and the shield member extends on the plane parallel to the road surface as a whole.

8. The power transmission device according to claim 1, wherein the shield member extends in such a direction that at least a part of the shield member includes a component in the power transmission direction.

9. The power transmission device according to claim 8, wherein the outer periphery of the shield member extends in the power transmission direction.

10. The power transmission device according to claim 1, wherein the power transmission device is a ground power supply device used to transmit a power to a vehicle in a wireless manner, and the coil is disposed on a road surface side with respect to a metal buried object on a road in which the metal buried object is buried.

11. The power transmission device according to claim 10, wherein the metal buried object is disposed in such a way that a distance from the coil is 400 mm or less, or in such a way that the distance from the coil is twice or less a distance between a power reception coil of the vehicle that receives the power in a wireless manner and the coil.

12. The power transmission device according to claim 1, comprising an inverter circuit that supplies the power to the coil.
